(19) United States
(12) Patent Application Publication
(10) Pub. No.: US 2025/0319504 A1
(43) Pub. Date: Oct. 16, 2025

(54) DUST MITIGATING NANOTEXTURE AND METHOD OF MAKING

(71) Applicants: SMART MATERIAL SOULUTIONS, INC., Raleigh, NC (US); BOARD OF REGENTS, THE UNIVERSITY OF TEXAS SYSTEM, Austin, TX (US)

(72) Inventors: Stephen Furst, Raleigh, NC (US); Nichole Cates, Raleigh, NC (US); Lauren Micklow, Raleigh, NC (US); Chih-Hao CHANG, Austin, TX (US); Samuel Lee, Austin, TX (US)

(73) Assignees: SMART MATERIAL SOULUTIONS, INC., Raleigh, NC (US); BOARD OF REGENTS, THE UNIVERSITY OF TEXAS SYSTEM, Austin, TX (US)

(21) Appl. No.: 18/866,314

(22) PCT Filed: May 17, 2023
(86) PCT No.: PCT/US2023/022541

§ 371 Date: Nov. 15, 2024

Related U.S. Application Data
(60) Provisional application No. 63/342,762, filed on May 17, 2022.

(51) Int. Cl. B08B 17/06; B29C 33/38; B29C 33/42; B29C 59/02; B29K 69/00; B29K 79/00

(52) U.S. Cl. CPC B08B 17/06; B29C 33/3842; B29C 33/424; B29C 59/022; B29K 2069/00; B29K 2079/08

(57) ABSTRACT

A micro- or nanotextured or structured surface and methods of making and using the same are provided. A structured or textured surface can comprise a substrate and a textured surface comprising a plurality of features and configured to reduce surface adhesion of a particulate to the structured surface. The micro- or nanotextured surface can be replicated using highly scalable processes, such as roll-to-roll nanoimprint lithography and roll-to-roll thermal embossing onto the substrate by a master mold, which can be created by ultrasonic nanocoining.

### CROSS-REFERENCE TO RELATED APPLICATIONS

This application claims the priority benefit pursuant to 35 U.S.C. § 119(e) to U.S. Provisional Patent Application No. 63/342,762 filed on May 17, 2022, the contents of which are herein incorporated by reference in their entirety.

### STATEMENT REGARDING GOVERNMENT FUNDING

This invention was made with government support under contract 80NSSC21C0252 awarded by the NASA. The government has certain rights in the invention.

### FIELD

The technology described herein generally relates to micro- and nanostructured surfaces, and more particularly to micro- and nanostructured surfaces and their fabrication to reduce and/or mitigate adhesion of particulates.

### BACKGROUND

Particulate contamination is a major challenge in applications requiring highly engineered materials and surfaces, for example in space exploration as lunar dust is particularly damaging to such materials and surfaces due to its highly abrasive and electrically charged nature. In such applications, dust mitigation becomes critical where key infrastructures such as habitats, solar panels, greenhouse windows, space suits, surface rovers, and excavation equipment can be contaminated and degraded by particulate matter over time. Conventional dust mitigation strategies or techniques such as wiping or blowing dust or particulates off of a surface require consumption of time and energy, add mass to a payload, and can be inefficient.

Further, current dust mitigation surfaces and techniques are limited by their performance, manufacturability, and scalability. Consequently, there is a need for improved particulate mitigation surfaces and their fabrication that can reduce the surface energy and/or tune the topographical geometry thereof that can minimize particle contamination without external stimuli.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards micro- and nanostructured surfaces, and their design and fabrication, which mitigate dust and/or particulate adhesion thereto, through reduction of adhesion by the dust and/or particulate to a surface, for example by reducing surface energy or surface contact area. According to some aspects, scalable manufacturing processes can be implemented to produce micro- and nanostructured surfaces for dust and/or particulate mitigation and/or reduction. According to some aspects, methods of manufacturing such micro- and nanostructured surfaces are provided using scalable methods including mechanical indenting which can further be implemented using roll-to-roll patterning techniques.

According to some embodiments, a micro- and/or nanotextured surface is provided, for example a structured surface. The surface can comprise a substrate and a textured surface, wherein the textured surface comprises a plurality of features configured to reduce surface adhesion of a particulate.

According to some further embodiments, a method for fabricating a structured surface is provided. The method can comprise replicating a nanotexture into the surface of a substrate material or another material adhered to the substrate by a master mold or stamp having the nanotexture thereon. In some instances, the nanotexture is imparted to the master by ultrasonic nanocoining.

According to aspects of the technology described herein, structured surfaces (e.g. micro- and/or nanostructured surfaces) for particulate mitigation and the highly scalable fabrication processes thereof as well as the design and tuning of such structured surfaces are provided. In one example the structured surfaces demonstrate more than a 90% decrease in percent area covered with dust when compared to a smooth surface of the same material.

In some embodiments, a textured surface is provided comprising a plurality of features, the plurality of features configured to reduce surface adhesion of a particulate, wherein the texture is generated by mechanically indenting the texture into a surface and/or by a texture transfer process.

In some further embodiments, a method of forming a textured surface is provided, the method comprising providing a surface, generating a texture on a mold to form a textured mold, and replicating the texture from the mold to the surface to form the textured surface, wherein the textured surface comprises a plurality of features configured to reduce surface adhesion of a particulate.

Additional objects, advantages, and novel features, and various embodiments of the technology will be set forth in part in the description that follows, and in part will become apparent to those skilled in the art upon examination of the following, or can be learned by practice of the invention.

### BRIEF DESCRIPTION OF THE DRAWINGS

Aspects of the present disclosure can be better understood with reference to the following drawings. The components and/or features in the drawings are not necessarily to scale, with emphasis instead being placed upon clearly illustrating the principles of the disclosure. Aspects of the technology presented herein are described in detail below with reference to the accompanying drawing figures, which are not necessarily drawn to scale, wherein:

FIG. 1 shows a scanning electron microscopy (SEM) image of an example textured surface illustrating the seam between a smooth surface that is covered with dust (left) and a patterned surface that has substantially less dust adhesion (right), in accordance with some aspects of the technology described herein;

FIG. 2A shows an illustration of an example textured surface, in accordance with some aspects of the technology described herein;

FIG. 2B shows an illustration of an example textured surface, in accordance with some aspects of the technology described herein;

FIG. 2C shows an illustration of overlayed example textured surfaces, in accordance with some aspects of the technology described herein;

FIG. 2D shows a SEM image of an example textured surface illustrating a reduced contact area for dust particles, in accordance with some aspects of the technology described herein;

FIG. 3A shows images of example smooth and textured surfaces prior to dust contamination, in accordance with some aspects of the technology described herein;

FIG. 3B shows images of example smooth and textured surfaces after dust contamination, in accordance with some aspects of the technology described herein;

FIG. 3C shows images of example smooth and textured surfaces after dust contamination and tilting, in accordance with some aspects of the technology described herein;

FIG. 4 graphically illustrates dust coverage area on example surfaces, in accordance with some aspects of the technology described herein;

FIG. 5A illustrates an example patterned die and a mold before an indent, in accordance with some aspects of the technology described herein;

FIG. 5B illustrates an example patterned die and a mold during an indent, in accordance with some aspects of the technology described herein;

FIG. 5C illustrates an example patterned die and a mold after an indent, in accordance with some aspects of the technology described herein;

FIG. 6 illustrates aspects of an example nanocoining indenting processes, in accordance with some aspects of the technology described herein;

FIG. 7A shows a photo of an example cylindrical drum mold that can be used in texturing a surface, in accordance with some aspects of the technology described herein;

FIG. 7B shows a photo of an example cylindrical sleeve that can be used in texturing a surface, in accordance with some aspects of the technology described herein;

FIG. 7C shows a photo of an example shim that can be used in texturing a surface, in accordance with some aspects of the technology described herein;

FIG. 8 illustrates an example thermal-embossing process, in accordance with some aspects of the technology described herein;

FIG. 9A shows an SEM image of an example textured surface, in accordance with some aspects of the technology described herein;

FIG. 9B shows an SEM image of an example textured surface, in accordance with some aspects of the technology described herein;

FIG. 9C shows an SEM image of an example textured surface, in accordance with some aspects of the technology described herein;

FIG. 9D shows an SEM image of an example textured surface, in accordance with some aspects of the technology described herein;

FIG. 10 shows an example mold for generating a textured surface and example textured surfaces, in accordance with some aspects of the technology described herein;

FIG. 11 shows confocal laser microscopy images of example surfaces both before and after spinning, in accordance with some aspects of the technology described herein;

FIG. 12 graphically illustrates dust coverage area of example surfaces before and after spinning, in accordance with some aspects of the technology described herein;

FIG. 13 graphically illustrates dust coverage area of example surfaces before and after spinning, in accordance with some aspects of the technology described herein;

FIG. 14 graphically illustrates dust coverage area of example surfaces after tilting in air and in vacuum, in accordance with some aspects of the technology described herein

FIG. 15A is an SEM image of an example textured surface, in accordance with some aspects of the technology described herein;

FIG. 15B is an SEM image of a seam between a smooth surface and an example textured surface illustrating dust adhesion properties, in accordance with some aspects of the technology described herein;

FIG. 15C is an SEM image of a seam between a smooth surface and an example textured surface illustrating dust adhesion properties, in accordance with some aspects of the technology described herein;

FIG. 16 shows SEM images particles wedged between features of an example textured surface, in accordance with some aspects of the technology described herein;

FIG. 17 shows SEM images of particulate accumulation on various regions of an example textured surface, in accordance with some aspects of the technology described herein;

FIG. 18 shows a diagram illustrating an example process of generating a textured surface, in accordance with some aspects of the technology described herein;

FIG. 19 shows a SEM image of an example textured surface and a photograph of the example textured surface, in accordance with some aspects of the technology described herein;

FIG. 20A shows a 3D topographic image of an example smooth surface, in accordance with some aspects of the technology described herein;

FIG. 20B shows a 3D topographic image of an example textured surface, in accordance with some aspects of the technology described herein;

FIG. 20C shows a 3D topographic image of an example smooth surface, in accordance with some aspects of the technology described herein; and

FIG. 20D shows a 3D topographic image of an example textured surface, in accordance with some aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

Further, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

At a high level, embodiments of the present technology are directed to textured or structured surfaces and methods and/or processes of forming or generating or otherwise creating textured or structured surfaces. For instance, in one example embodiment a textured surface can comprise a plurality of features and/or a pattern configured to reduce surface adhesion of a particulate to the textured surface.

As will be appreciated, dust or particulate accumulation can be detrimental to optical elements, electronic devices, and mechanical systems and a significant problem in, for example, space missions or renewable energy deployment, among other applications. According to the technology described herein, micro- and/or nano-structured, patterned, and/or textured surfaces that mitigate or reduce dust or particulate and their design and fabrication are provided. Accordingly, textured or structured surfaces can be formed on surfaces, substrates and/or films that can significantly reduce or mitigate dust and/or particulate adhesion to such surfaces. In some instances, surface structures can be designed to operate to reduce contact area with respect to particulate materials and/or contaminants, which can reduce the adhesion force of a particle to the surface. In some other instances, surface structures can be treated, for example with silane, to reduce surface energy. According to aspects of the present technology, the design and generation of a surface structure (i.e. structured surface, textured surface) can be implemented and tuned to reduce a surface energy associated with a surface, and further such surface textures or structures can be produced by scalable methods using, for instance, micro- and nanoindenting methods such as nanocoining and roll-to-roll embossing, nanoimprinting processes, or through the use of molds and texture transfer processes.

According to some aspects, the surface structures described herein can minimize potential negative impacts that particulate matter, such as lunar dust, may have on space exploration equipment. For example, the structures described herein can exhibit a particulate reduction of greater than 90% with respect to a coverage area of a surface when compared to a planar surface of the same or similar materials. In some other aspects, the technology described herein can be utilized to reduce and/or mitigate dust contaminants in terrestrial applications, such as for example windows, solar cells, including cover glass, displays, radiator strips, and curved camera optics, among other applications. In some other aspects, substrates and/or surfaces describes herein, such as surface structures for instance for dust-mitigation surfaces, can be implemented in a number of different materials including, polymer, epoxy, glass, oxides, metals, among others.

In some aspects, particulate mitigation on a surface can be further improved or enabled by reducing contact area between particles and a surface and can be achieved in some aspects through surface parameters of the texture or structure of a surface (i.e. textured surface), including structure or feature pitch, structure or feature radius, and/or structure or feature height, among other surface structure parameters.

According to some aspects of the technology described herein, surfaces such as textured and/or patterned surfaces, and/or surface structures can provide improvements over conventional surfaces by way of passively removing particulates, such as dust, on a surface without external or additional inputs. Additionally, surfaces described herein can be highly scalable for various applications or fabrication processes.

According to some embodiments of the technology described herein passive dust or particulate mitigation surfaces can be formed from scalable micro- and/or nanopatterning processes that can create textures, such as micro- and/or nanotextures or structures on surfaces to form a textured or structured surface which can substantially reduce or mitigate dust or particulate adhesion to such surfaces. In some instances, a textured surface or structured surface (such as a micro- and/or nanotextured or structures surface) can exhibit greater than 70%, greater than 80%, greater than 90%, for instance greater than 93%, reduction in a surface area covered with dust or particulate matter compared to a smooth surface of the same material.

In some embodiments, a textured (or structured) surface is provided comprising a plurality of features, which in some instances form a pattern, with the plurality of features configured to reduce surface adhesion of a particulate to the textured surface. In some instances, the texture, or formation of the textured surface, is generated by mechanically indenting the texture into a surface and/or by a texture transfer process. In some instances, a direct texturing process can comprise forming the texture into a surface by indenting the texture into a about smooth substrate or surface to form the textured surface. In some other instances, an indirect texturing process can comprise initially forming a textured mold, template, and/or photomask and subsequently transferring a texture or pattern into a substrate or surface. In some instances, the texture transfer process comprises creating a texture on a mold and replicating the texture into the surface by at least one of embossing, etching, and nanoimprint lithography. In some other instances, the texture is generated into a mold by a mechanical indenting through nanocoining and/or step-and-repeat indenting.

According to some aspects, the plurality of features (i.e. that form the texture or pattern) comprise a plurality of periodically, aperiodically, regular, irregular, and/or stochastically arranged features, and wherein at least a portion of the plurality of features have center-to-center distances of 100 nm to 5000 nm, for instance from about 100 nm to about 1000 nm, from about 100 nm to about 500 nm, from about 500 nm to about 1000 nm, from about 100 nm to about 400 nm, about 150 nm, about 300 nm, about 400 nm, and/or about 500 nm. Further, at least a portion of the plurality of features can have a height of at least one third of the pitch. Even further, at least a portion of the plurality of features can have a radius of curvature less than a quarter of a pitch. In some instances, the plurality of features are combined with additional features, for instance a regular or irregular array or set of larger features. In some instances, the array or set of larger features can have center-to-center distances of 1 μm to 1000 μm. In some other instances the array of larger features can be a microlens, a linear grating, or another structure, not inconsistent with objectives described herein. The about smooth substrate/surface and/or the textured or patterned surface can in some example instances be a metal, ceramic, sol-gel, glass, or polymer. Further the about smooth substrate/surface and/or the textured or patterned surface can be coated with a low energy coating, for example silane, fluorine, self-assembled monolayer (SAM), or another surface treatment not inconsistent with objectives described herein.

In some other embodiments, a method of forming a textured or patterned surface is provided. A method of forming or generating a textured or patterned or structured surface can comprise providing a substrate or surface (e.g. a smooth or an about smooth substrate or surface), generating a texture on a mold to form a textured mold, and subsequently replicating the texture from the mold to the surface to form the textured surface, wherein the textured surface comprises a plurality of features configured to reduce surface adhesion of a particulate. In some example instances, a substrate or surface can be greater than 1 m², greater than 5 m², greater than 10 m², greater than 25 m², greater than 50 m². In some other example instances, a substrate or surface can be larger than an 8-inch wafer.

In some instances, a direct texturing process can comprise forming the texture into a surface by mechanically indenting the pattern or texture into an about smooth substrate or surface to form the textured or structured surface. In some other example instances, an indirect texturing process can comprise initially forming a textured mold, template, and/or photomask and subsequently transferring a texture or pattern into a substrate or surface. Texturing processes or methods can additionally be combined in some cases. In some aspects the textured or patterned mold is generated by at least one of embossing, etching, and nanoimprint lithography. Further the replicating of the texture or pattern can be done via a plate-to-plate, roll-to-plate, roll-to-roll process, or other replication process not inconsistent with objectives described herein.

According to some aspects, the method can form the textures surface having a plurality of features that can be a plurality of periodically, aperiodically, regular, irregular, and/or stochastically arranged features, and wherein at least a portion of the plurality of features have center-to-center distances of 100 nm to 5000 nm, for instance from about 100 nm to about 1000 nm, from about 100 nm to about 500 nm, from about 500 nm to about 1000 nm, from about 100 nm to about 400 nm, about 150 nm, about 300 nm, about 400 nm, and/or about 500 nm. As will be appreciated the features can be one-dimensional, two-dimensional, and/or three-dimensional, that is the features or set of features can have varying feature distances in three planes. Further, at least a portion of the plurality of features can have a height of at least one third of the pitch. Even further, at least a portion of the plurality of features can have a radius of curvature less than a quarter of a pitch. In some instances, the plurality of features are combined with additional features or an additional array or set of additional features, for instance a regular or irregular array or set of larger features. In some instances, the array or set of larger features can have center-to-center distances of 1 μm to 1000 μm. In some other instances the array of larger features can be a microlens, a linear grating, or another structure, not inconsistent with objectives described herein. The about smooth substrate/surface and/or the textured or patterned surface can in some example instances be a metal, ceramic, sol-gel, glass, or polymer. Further the about smooth substrate/surface and/or the textured or patterned surface can be coated with a low energy coating, for example silane, fluorine, self-assembled monolayer (SAM), or another surface treatment not inconsistent with objectives described herein. A textured surface described herein and/or formed by the method or process can reduces particulate contamination relative to a planar surface of the same material by at least 70%, by at least 80%, by at least 90%, or by at least 93%.

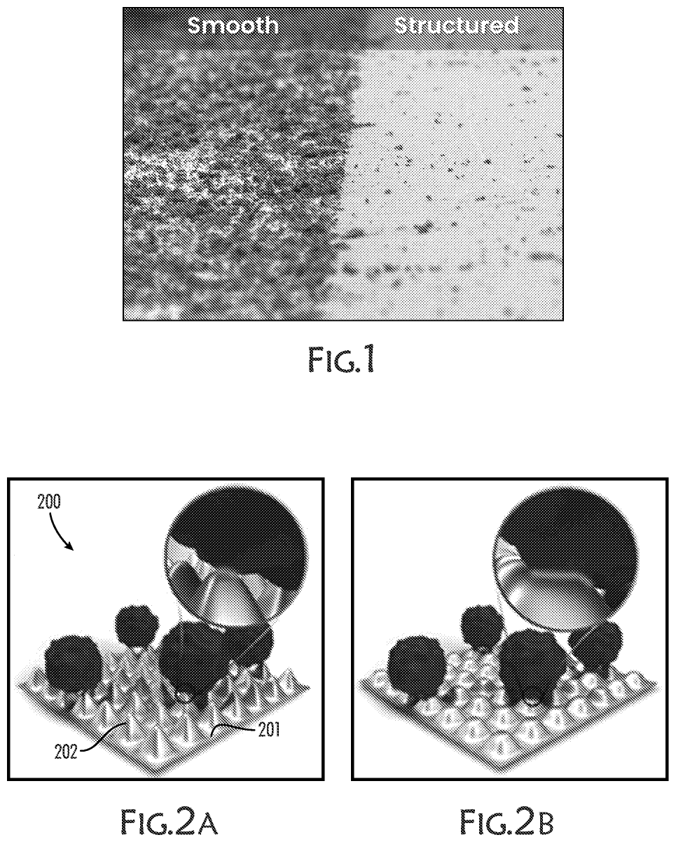

Referring to FIG. 1, FIG. 1 is a scanning electron microscopy (SEM) image showing dust adhesion to a smooth silane-treated polycarbonate surface and substantially less dust adhesion to a nanopatterned or nanostructure surface of the same material, in accordance with aspects of the technology described herein. Accordingly, the nanostructured surfaces (also referred to as structured, microstructured, nanopatterned, micropatterned, or patterned surfaces herein) employ features to reduce dust or particulate adhesion by reducing the contact area between the dust particle and the nanostructured surface and further can make it easier to remove dust or particulate contaminants and reduce the probability that dust or particulates accumulate on the surface in the first place.

It will be appreciated that the dust mitigation features are not only relevant in space but on earth applications as well, for instance in solar panels, windows, and lenses, for example. Additionally, the dust mitigating surfaces described herein can also achieve other desirable properties, such as being anti-microbial, anti-viral, anti-bacterial, self-cleaning, or superhydrophobic.

According to some aspects, the fabrication of nanopatterned dust mitigating surfaces are scalable to be applied over large areas. It will be appreciated that generally, large-area fabrication of micro- and nanotextured surfaces are not feasible with conventional methods or prohibitively expensive as it requires trillions of nanoscale features. Further, while traditional roll-to-roll (R2R) nanoimprint lithography, R2R thermal embossing, and other R2R nanopatterning processes can provide methods of scalable manufacturing of micro- or nanotextured films by pressing a textured metal drum into a polymer, these methods are largely hampered by the high costs of large-area drum molds and their creation. According to aspects of the present technology, large-area drum molds can be fabricated through mechanical indenting methods such as nanocoining, which can be hundreds of times faster than traditional nanopatterning processes, such as electron-beam lithography, and can create seamless drum molds that can be implemented in highly scalable roll-to-roll imprinting.

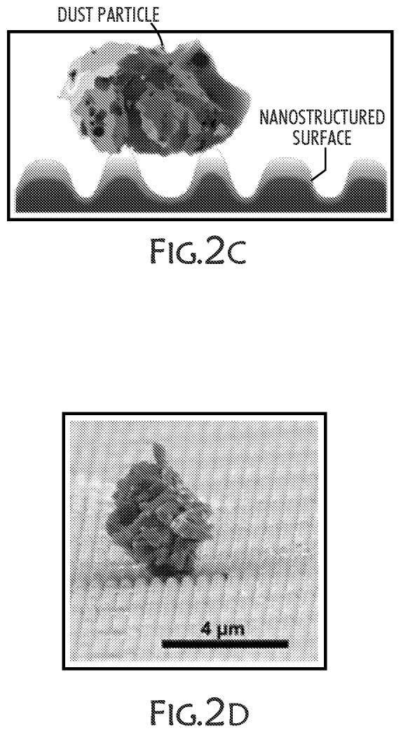

Active dust mitigation systems use external actuation (e.g. electrical, liquid, forced air) to overcome particle-surface adhesion, but require energy to operate. Active systems include electrodynamic dust shielding (EDS), brushing, fluid or air sprays, or mechanical vibration. Passive dust mitigation systems, such as those described herein, reduce the probability of particle contaminiation or adhesion while requireing no energy and adding negligible mass to a payload. For example, structured surfaces (also referred to as patterned or textured surfaces) can reduce the contact area between dust particles and a surface thereby minimizing electrostatic and van der Waals forces making dust or particulate matter less likely to be attracted to a surface and furthermore easier to remove. Referring to FIG. 2, FIG. 2A shows an illustration of the reduced contact area between a dust particle and a structured surface. FIG. 2A shows a tyextured or structured surface 200 with respect to particulate, with a surface 201 and a plurality of fatures 202. FIG. 2A and FIG. 2B shows an illustration of a surface that is structured with features, with the features of FIG. 2B having a larger radius of curvature than that of the features in FIG. 2A. The features in FIG. 2B have reduced contact area with a dust particle compared to the contact area that dust particle would have with a smooth surface, but an increased contact area with the dust particle compared to the surface in FIG. 2A that has features with a smaller radius of curvature. FIG. 2C shows another illustration of the reduced contact area between a dust particle and a surface with nanoscale features. FIG. 2D shows an SEM image of a dust particle sitting on a nanostructured surface with a relatively small contact area between the dust and the nanostructured surface. Such surfaces as described herein can further be combined with chemical surface treatments and active mitigation techniques (such as EDS) to further enhance dust-mitigation properties.

According to some aspects of the present technology, and at a high level, nanostructured surfaces and their fabrication are provided that can be configured to remove more than 90% more lunar dust particles than smooth samples of the same material solely via gravity. The structures can be fabricated using a highly scalable nanocoining and/or nanoimprint process, where nanostructures with precise geometry and surface properties are patterned on a substrate, for instance polycarbonate substrates. In some other aspects, nanostructures or nanotextures may be patterned on other materials, including but not limited to glass, metals, polycarbonate, polyimide, FEP, PTFE, and PET. Accordingly, functional nanotextures can be transferred and/or created and/or formed on material substrates by imprinting processes, such as roll-to-roll imprinting processes using, for example, seamless nanocoined drum molds.

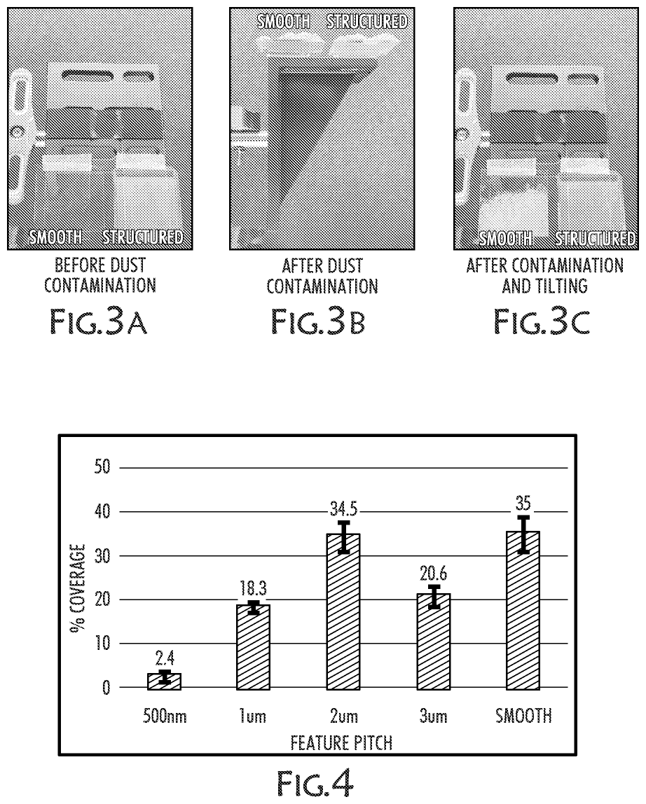

According to some embodiments, passive micro- and/or nanotextured dust mitigation surfaces are provided that can be fabricated by highly scalable processes. In one example embodiment, a silane-treated polycarbonate film having a 500 nm pitch embossed surface texture can provide a 93% reduction in dust adhesion compared to a smooth film or about smooth surface of the same material. Embossed surface textures can be provided to a substrate or film material through the use of molds or stamps having micro- and/or nanopatterns thereon. Various textured molds having micro- and/or nanopatterns thereon may be utilized to replicate the patterns or textures into a material, such as polycarbonate. Referring to FIG. 3, comparative photos illustrate example smooth (or about smooth surfaces) compared to textured or structured surfaces described herein. FIG. 3A shows a comparison between silane-treated polycarbonate films with a smooth surface (left) and a nanopatterned surface (e.g. a 500 nm pitch pattern) before contamination with a lunar dust simulant. FIG. 3B shows the same two films after contamination with a lunar dust simulant, and FIG. 3C shows the films after tilting to remove the dust with gravity. In FIG. 3C, a substantial amount of lunar dust simulant remains adhered to the smooth film, whereas the patterned film is largely free of dust. It will be appreciated that scalable fabrication processes can efficiently fabricate the metal molds to create micro- and/or nanopatterned textured surfaces into a wide array of materials, such as polymer film, for instance using roll-to-roll (R2R) embossing. FIG. 4 plots the percentage of area covered with lunar dust simulant on silane-coated polycarbonate surfaces with different sized structures after contamination with dust and tilting to remove dust with gravity and demonstrates a 93% reduction in the dust coverage area for the film textured with 500 nm pitch features relative to the smooth film.

Aspects of the present technology can further include fabrication of molds with, for example, patterns/textures with 2 μm, 1 μm, and 500 nm pitch features using nanopatterning techniques such as the nanocoining indenting process; replication and metrology by replicating the molds into various materials using processes like thermal embossing or nanoimprint lithography; and chemical treatment such as silanization, fluorination, and the addition of self-assembled monolayers (SAMs) to polymer films to reduce dust adhesion to an array of different surfaces.

According to some example embodiments, a surface or textured surface is provided comprising a plurality of features, where the textured surface and/or the plurality of features are configured to reduce surface adhesion of a particulate to the surface and/or a portion of the features. In some instances, the texture (or pattern or structure) is generated or otherwise created through mechanically indenting the texture or the pattern or structure into the surface (e.g. into a smooth substrate to form or create the textured surface). In some other instances, the texture (or pattern or structure) is generated or otherwise created through mechanically indenting a mold which can replicate the texture (or pattern or structure) into the surface (e.g. replicated into a smooth substrate to form the textured surface. In some instances, a mold is formed by an indenting process, nanocoining and/or step and repeat indenting.

Various embodiments of the present technology will now be discussed in more particular detail with regards to the following non-limiting examples of various aspects of a textured or patterned surface and methods or processes of creating the same. Further, various portions of the examples and the foregoing discussion of the technology methods that can be carried out. In some instances, methods include steps and/or blocks however these do not necessarily have to be carried out in a prescribed order and can further include additional steps and/or blocks or substeps. In some instances, a method does not necessarily have to require a given step.

### Mold Fabrication

According to some aspects, molds with textures designed to reduce dust adhesion are created. Modeling has shown that adhesion forces between a dust particle and a textured surface can be minimized by decreasing the surface energy of the textured surface and by the creation of features that are closely packed and with a sharp point to reduce the contact area as much as possible.

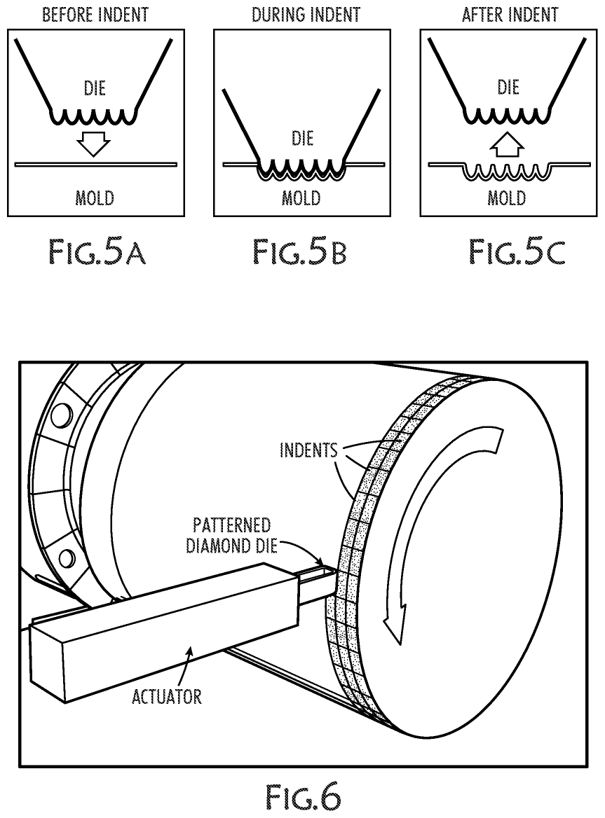

According to some aspects, mechanical indenting processes such as ultrasonic nanocoining and step-and-repeat indenting processes can be used to pattern the molds. These indenting processes use a nanopatterned die to repeatedly indent the surface of the mold. The die is often made of diamond due to its high hardness and toughness, but other die materials can also be used. The die can be nanopatterned with nanopatterning processes including focused ion beam (FIB) milling, lithography processes, and direct writing processes. The patterned die is indented into the mold surface, which can be made of a metal, ceramic, polymer, or other material. Referring to FIG. 5, FIG. 5A shows an illustration of a die and mold before indenting. FIG. 5B shows how indenting creates the inverse of the die's features in the mold's surface. After indenting, these inverted features remain in the molds surface as illustrated in FIG. 5C. In ultrasonic nanocoining, an ultrasonic actuator indents the diamond die into the surface of a rotating drum tens of thousands of times per second. This process rapidly covers the surface of the mold with a seamless spiral of indented features as illustrated in FIG. 6. Step-and-repeat indenting can also be used to replicate a die's pattern into a mold's surface. During step-and-repeat indenting, a die is indented into a mold, removed from the mold. Then, the die's position is translated with respect to the mold's surface and the process is repeated to create an array of indents.

As will be appreciated, a mechanical indenting process (either a direct indenting process into a substrate to form a textured surface, or an indirect indenting process which utilizes a textured or patterned mold to transfer a texture onto or into a substrate to form a textured surface) offers an improvement over other pattern replication processes by increased speed at which a textured surface can be formed and through scalability to larger surface. For example, in one aspect, the process can seamlessly pattern a large, metal mold or drum mold at a rate of 1-2 square inches per minute, more than 500 times faster than alternative techniques such as electron beam lithography. In other instances, this metal mold can then be used to transfer the pattern again into a softer material, such as a polymer, at a rate of several square meters per minute or more. As will be appreciated, a seamless pattern in, for example, the cylindrical mold ensures there is no waste in the replica, that is, the textured surface.

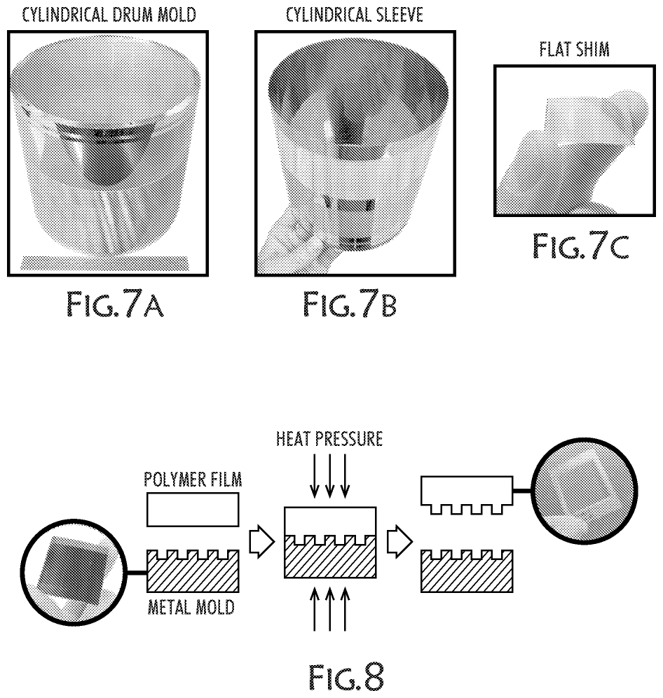

Mechanical indenting processes like those described above can create molds in several form factors, pictured in FIG. 7. FIG. 7A shows a cylindrical drum mold or tube, FIG. 7B shows a cylindrical sleeve, and FIG. 7C shows a flexible shim. Sleeves are ideal for thermal embossing because they heat and cool rapidly and can be precisely handled on an air mandrel system. Cylindrical drum molds and sleeves can be used on roll-to-roll (R2R) nanopatterning setups. Alternatively, sleeves can also be cut up, as they were in this project, to create shims for batch imprinting processes.

### Polymer Replication

A textured mold with dust-mitigating properties may be an end product itself, but typically the patterns on a metal mold are replicated into a polymer to create large-area textured polymer films through UV curing of polymer precursors or by thermal embossing of thermoplastics. FIG. 8 shows the thermal-embossing process used to replicate the pattern from a patterned metal mold into a patterned polymer film. Various parameters including temperature, pressure, settling time, and cooling conditions were tuned for the thermal-embossing processes. The UV-cured replicas, which were made by UV curing of Norland Optical Adhesive 72 (NOA72), are shown because NOA72 tends to have very good fidelity; it replicates the features in the mold with minimal shrinkage during curing. In this study, batch imprinting processes such as plate-to-plate processes were used, but continuous roll-to-roll (R2R) and roll-to-plate (R2P) processes can also be used to replicate a mold's pattern into the surface of another material such as a polymer.

The polymer used for replicas in the initial study was polycarbonate, but the process can be applied to many materials including Tefzel (ethylene tetrafluoroethylene, ETFE), Zeonor (cyclic olefin copolymer, COC), polyethylene terephthalate (PET), polytetrafluoroethylene (PTFE), polyimide (Kapton), and many other materials.

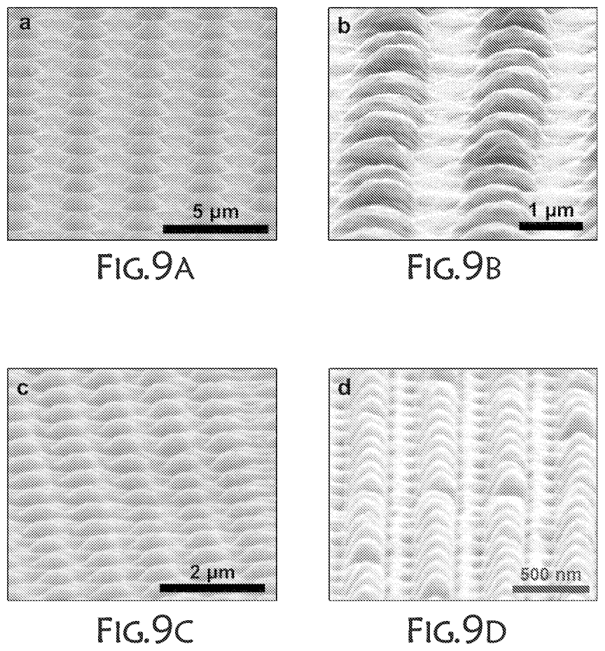

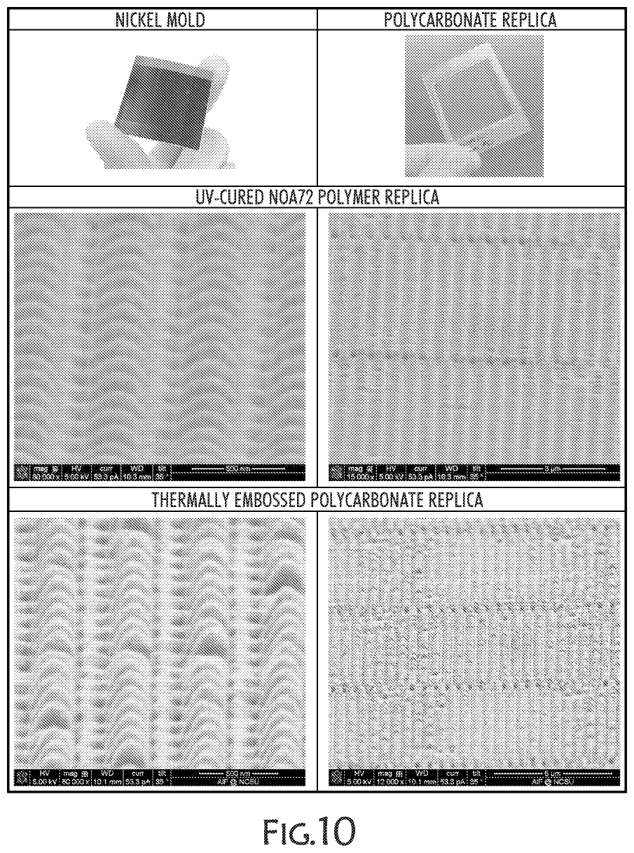

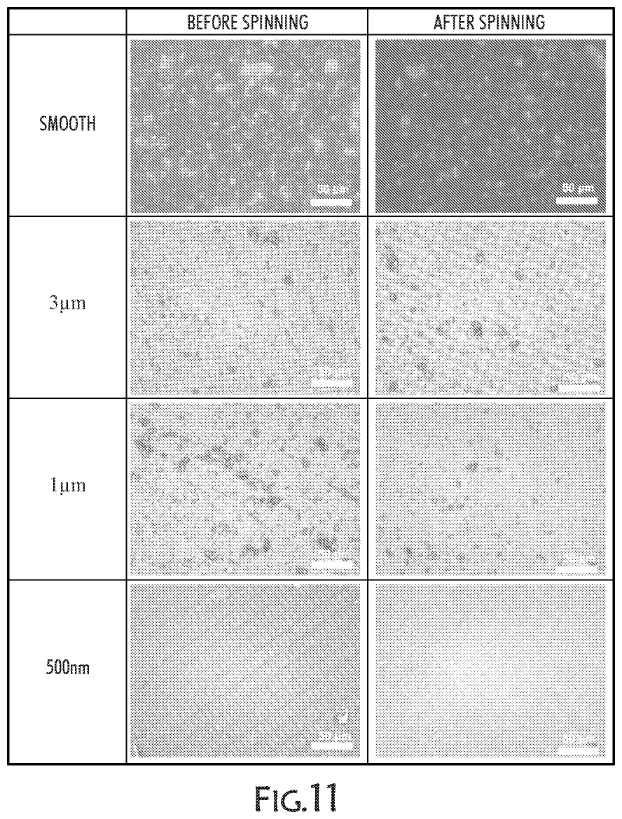

SEM images of polymer replicas of molds of four of the patterns that were tested are shown in FIG. 9. Referring to FIG. 9, FIG. 9A shows features with a pitch of 3 microns, FIG. 9B shows features with a pitch of 2 microns, FIG. 9C shows features with a pitch of 1 micron, and FIG. 9D shows features with a pitch of 500 nm (0.5 microns). FIG. 10 shows a photo of the nickel shim mold and a polycarbonate replica as well as SEM images of a UV-cured NOA72 polymer replica an a thermally embossed polycarbonate replica created from the nickel shim mold. Silane-treated polycarbonate with the pattern shown in FIG. 9 is the same pattern that is shown in FIGS. 1, 2, and 3 and is the pattern that exhibited a 93% decrease in the am in the area covered by lunar dust simulant compared to a smooth sample in FIG. 4.

Side-angle SEM images can be used to extract quantitative profile metrics of a patterned substrate or surface. The feature profiles are extracted by manually selecting points on the profile of a feature and then exported to MATLAB where the data is transformed to account for the sample tilt and the tops of the features are fit with a best-fit circle. Using this procedure, the radii of the tops of the features with periods of 3, 2, 1, and 0.5 microns are 1.07, 0.68, 0.56, and 0.15 microns, respectively.

### Chemical Treatment

The adhesion force between a particle and a structured surface is dependent on the contact radius of the surface features and the work of adhesion, which can be minimized by treating the substrate surface with a low-energy monolayer or coating such as a silane or fluorination coating. This can be accomplished, for example, by cleaning the substrate with oxygen plasma etching to activate the hydroxyl groups and treating the surface via vapor phase deposition.

In some embodiments, the polycarbonate samples are 30×30 mm in area and are cleaned with isopropanol and treated with oxygen plasma etching (Harrick Plasma, PDC-32G) for 10 s at 500 mTorr and 6.8 W to activate the surface hydroxyl group for surface treatment. The sample is then placed inside a vacuum desiccator with a petri dish that contains 100 μL of trichloro (octyl) silane (97%, Sigma Aldrich). A vacuum pump is connected to the desiccator to bring the chamber pressure to 1 Torr range. When the pressure is at the desired reading, a vacuum pump is turned off and a 3-way valve is turned to ensure no pressure leakage. In this embodiment, the sample is left inside a vacuum desiccator for about 6 hours for a formation of monolayer of covalent bonds via vapor phase deposition.

### Dust Adhesion Results

To examine the effectiveness of the nanotexturing and silane treatment, a confocal laser microscope was used to image the samples and quantitatively measure the percent area coverage and particle distribution. The particles were counted based on the threshold set by the height of the structure, yielding quantitative information about the particle coverage and size distribution.

An optical metrology and image processing protocol was established to examine particle adhesion and quantify the effectiveness of the topographical modification and chemical treatment. The objective is to compare the dust coverage area and particle size distribution on the surface after particle removal via gravity and again after further removal by applying a centrifugal force. The experiments use lunar mare simulant (Exolith, LMS-1), which emulates the material composition of lunar dust and has a size distribution between 40 nm and 300 μm. The lunar mare simulant used in this work is 99% oxides with 46.9% SiO₂, 16.8% MgO, and 12.4% Al₂O₃. The chemical composition of dust particles found on Earth depends on location and is also mostly composed of oxides with silica being the highest by the weight percentage. A recent study of dust particles on solar panels consists of up to 80% oxides, with 65% SiO₂ and 13% CaCO_{3.8}. The main difference is that terrestrial dusts can include more than 10% of organic matters, such as pollen and moss, as well as traces of particulate contaminates in the environment, which have lower surface energy compared to oxides. The size distributions of terrestrial and lunar dust are similar with broad size distribution and peak particle size in the order of 10 μm range. The inspection method involves dispensing a layer of dust particles around 1 mm thick on the horizontally placed nanostructured samples with 100% coverage area and then removing the excess particles via gravity by tilting the sample vertically. The particles are then further removed using centrifugal force by spinning the substrate at 500 RPM. The microscopic images of the sample before and after spinning are analyzed with the image processing methods to identify the particles on the sample at a distance of r=10 mm to the center of rotation, where the centrifugal force is roughly three times the gravity (3G). The percent area of the substrate covered by dust and the particle size distribution can then be calculated, allowing the adhesion mitigation effects of the surface texture/treatment to be quantified.

Adhesion tests were performed on smooth and textured polycarbonate samples with 0.5, 1, and 3 μm pitch. LMS-1 lunar mare simulant was evenly distributed with 100% coverage on the samples and then tilted vertically to remove particles through gravity. The samples were then characterized using confocal microscopy before and after spinning the samples at 500 rpm to apply centrifugal force that may be able to remove some particles, as shown in FIG. 11.

The area covered with dust is greatly reduced as the structure pitch decreases from 3 to 0.5 μm. The reduction in particle coverage is even more significant after centrifugal force is applied by spinning the samples, indicating the particle adhesion force to textured sample is lower than to the smooth surface. Barely any particles are visible on the 500 nm pitch samples even prior to spinning.

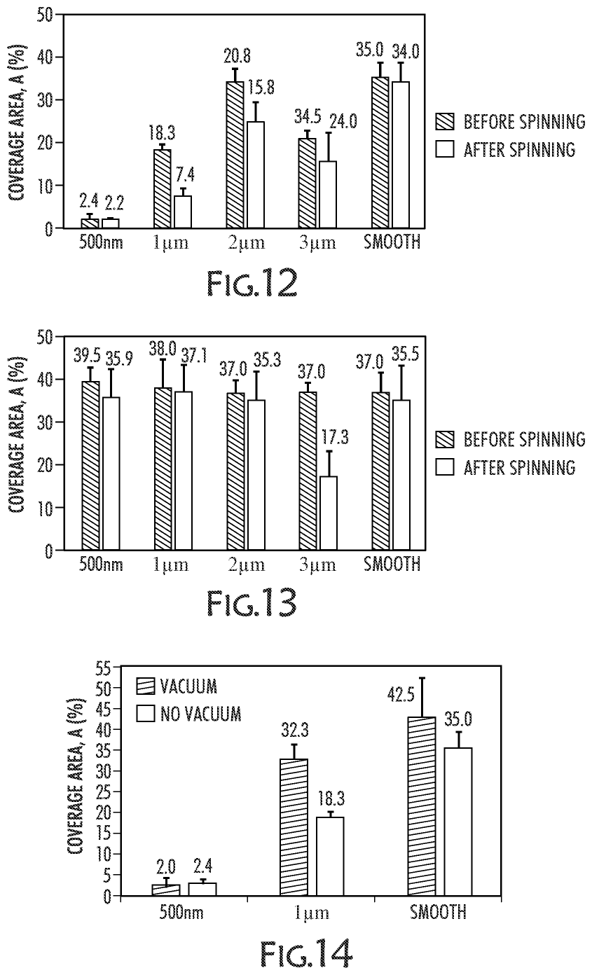

The percent area covered with for the silane-treated samples before and after spinning are shown in FIG. 12. Even prior to spinning, a significant reduction in the particle coverage can be observed by scaling down the structures due to the removal of dust by gravity before spinning. Before spinning, the particle coverage area after tilting to remove dust by gravity is reduced from 35% for the smooth sample to 2.4% for the 500 nm pitch sample, a 93.1% improvement. Applying centrifugal force can further reduce the particle coverage, except in the case of the smooth sample when the surface adhesion force is too strong. Note the data indicates that the 3 μm pitch structure sample has a lower % area coverage than the 2 μm pitch structure sample, which is not expected. This can be attributed to the non-optimal profile of the 2 μm pitch structures being shorter and are more rounded, resulting in a higher particle adhesion force. The image processing algorithm may also be underestimating the number of particles for the 3 μm sample, since any particle smaller than the structure is not counted. The data acquired through confocal microscopy consists of at least 10 data points for each sample to ensure measurement repeatability. The error bars on the coverage area plot represent the standard deviation of the measurements.

The effect of the silane treatment on the samples was also examined. FIG. 13 represents the percent area coverage of the smooth and textured polycarbonate samples without silane treatment. There is no improvement in dust-mitigation properties with scaling down the structured features. This indicates that the gravity and centrifugal forces are not sufficient to remove particles given the high surface energy. All the data points in FIG. 13 have approximately 35-40% dust coverage except for the 3 um pitch structure sample. This may be underestimating the actual count due to the large features. This result points to the importance of the surface treatment to reduce energy for the polycarbonate samples. That said, nanotexturing of materials with lower surface energy is likely to result in significant dust mitigation without the need for subsequent surface treatment.

A visual demonstration of the dust-mitigating properties of the 500 nm polycarbonate versus the smooth polycarbonate sample is shown in FIG. 3. In this experiment the two samples are jointly mounted horizontally on a rotating stage and half of both samples were covered with lunar dust simulant. The samples are then rotated slowly to the vertical position, where the dust particles are removed via gravity. It can be observed the smooth surface is still uniformly covered with a layer of dust, while the nanostructured sample remains clean. A side-by-side comparison of the samples prior to applying the dust illustrates the dust-mitigating properties of the nanostructured surfaces, that look the same. It is interesting to note that while the dust-coated region is obvious for the smooth sample, it cannot be detected on the 500 nm sample. The only place where dust can be observed on the 500 nm sample is along a scratch and at the boundaries where no structures are patterned.

The textured polycarbonate samples were also tested in vacuum to simulate the lunar environment. This experiment also serves as a method to examine the effect of humidity, which can result in capillary forces and increased particle adhesion. In these experiments silane-treated smooth and textured surfaces were characterized using the establish optical metrology protocols to quantify the particulate mitigation effectiveness after vertically tilting the samples in a vacuum desiccator. A coarse mechanical pump was used to bring the pressure to the 1 Torr range. The percent particle coverage area for smooth, 1 μm, and 500 nm pitch samples were quantified and compared with baseline data obtained previously in atmosphere, as shown in FIG. 14. The 500 nm pitch sample maintained its dust-mitigating properties in vacuum at 2% coverage area, this is similar to the adhesion data in atmosphere. The particle coverage areas increased to 42.5% for the smooth and 32.3% for the 1 μm pitch samples when tested in vacuum. However, the increase in coverage area can potentially be attributed to degradation of the structures due to repetitive testing and is the subject of future studies. Although it is unclear how significant a role humidity plays in the adhesion force based on the results, it is important to note that 500 nm pitch samples continued to effectively remove dust particles in vacuum.

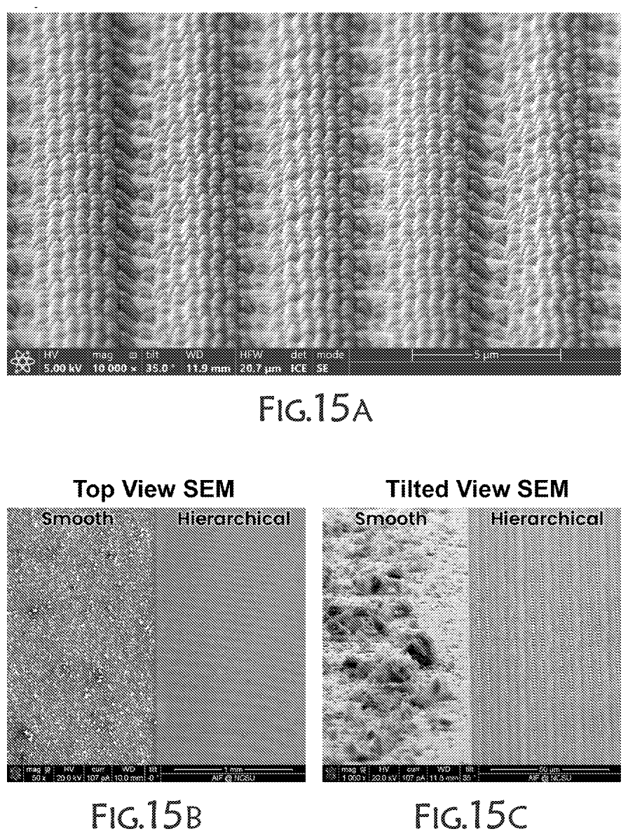

It was also found that 500 nm features can effectively remove dust particles when they are combined with larger features to create a hierarchical pattern. FIG. 15A shows an SEM image of hierarchical features consisting of 500 nm features on top of 4 micron features. FIG. 15B and FIG. 15C show a seam between a smooth film (left) and a hierarchically patterned film (right) with a silane coating after exposure to dust and removal with gravity due to tilting of the sample. The smooth films remain covered in dust, whereas the hierarchically patterned films are largely dust free. In addition to acting a dust-mitigating surfaces, these hierarchical features can be of interest for applications like light-trapping, self-cleaning coatings for solar panels that can take advantage the unique optical properties of these hierarchical features.

The key observation of these experiments is that the silane-treated nanostructured polycarbonate samples are highly effective in mitigating particle adhesion. Compared with the smooth polycarbonate samples, the particle coverage area is decreased by 93.1% just through gravity (35% versus 2.4% coverage area). We also observed an improvement in the particle-mitigating properties as the feature size is reduced, as predicted by our theoretical adhesion model. The applied centrifugal force at 500 RPM was effective in further reducing the particle coverage, especially for the larger structures where gravity alone is not sufficient to remove the particles. It is critical to note that surface treatment to lower the surface energy has a significant effect on the mitigating dust adhesion and can be applied to other textured surfaces of different materials (glass, metals, polymer, etc.), but this treatment may not be needed for materials with lower surface energies. The samples were also tested in a vacuum environment and the 500 nm pitch sample demonstrated 2.0% particle coverage area, this is similar to the dust-mitigating properties in atmosphere.

Additional experiments and analysis were conducted on the best-performing sample, with 500 nm pitch features. These samples have a transition zone where they abruptly change from a patterned to a smooth surface. As can be seen in FIG. 1, both the smooth and patterned regions were imprinted with the same mold that included an interface between the indented (patterned) and diamond-turned (smooth) surfaces. The SEM images show how lunar dust simulant accumulates on the smooth surface but is largely rejected on the textured region, with a sharp interface line confirming that the effect is indeed caused by the texture, as can be seen in FIG. 1.

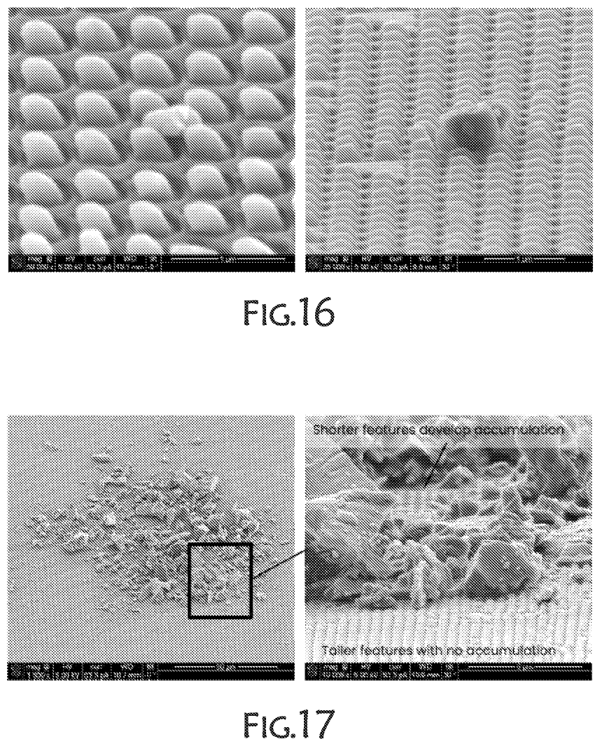

A close-up SEM image in FIG. 2D reveal interesting trends relating to the interface between dust particles and the surface at the nanoscale. First, the smallest, sub-micrometer dust particles tend to clump together, at least under atmospheric conditions. Also, the clumps sit on top of features, reducing contact area and thus adhesion force. This helps to explain why dust particles were few and far between within the patterned region. Some extremely small sub-micrometer particles were able to find their way into the 500 nm pitch nanostructures as shown in the SEM images in FIG. 16. These small particles become wedged between the features, where they are likely to stay due to their high contact area with the surface features.

The textured region also showed some sub-regions where dust did stick. However, upon closer review in FIG. 17, it can be seen that the areas where the dust accumulated actually had significantly shorter features. The normal features are about 250 nm tall and have a radius of about 120 nm, whereas the defective features that are only about 90 nm tall and have a radius of about 210 nm. The defective features are therefore significantly worse at repelling dust.

In another example, the pattern from the indented metal mold was transferred by a thermal embossing process into a fluoropolymer, FEP, first by heating the mold, then pressing the polymer against the mold, then cooling the mold while under pressure. Then, this patterned FEP was rinsed with IPA and tested for dust adhesion without the addition of a silane or other low-surface energy coating. In this case, the patterned surface exhibited reduced dust adhesion relative to a smooth surface, even without the monolayer coating. This may be because of the fact that the FEP material has a low surface energy intrinsically. This example eliminates the step of applying a low surface energy coating and therefore adds the benefit of reduced processing time and cost.

In another example, the pattern in the indented metal mold was transferred into polycarbonate using thermal embossing, but then this polycarbonate was replicated again into a second-generation soft, elastomeric mold/stamp. This soft mold/stamp was used to imprint a thin layer of UV cure resist that was spin-coated onto glass. The resist was cured by exposing it to UV light while it was in contact with the elastomeric mold, then the pattern was transferred through the resist using a reactive ion etch. This same process, diagrammed in FIG. 18, can be used to transfer a pattern into a wide array of materials, including metals, ceramics, oxides, and others.

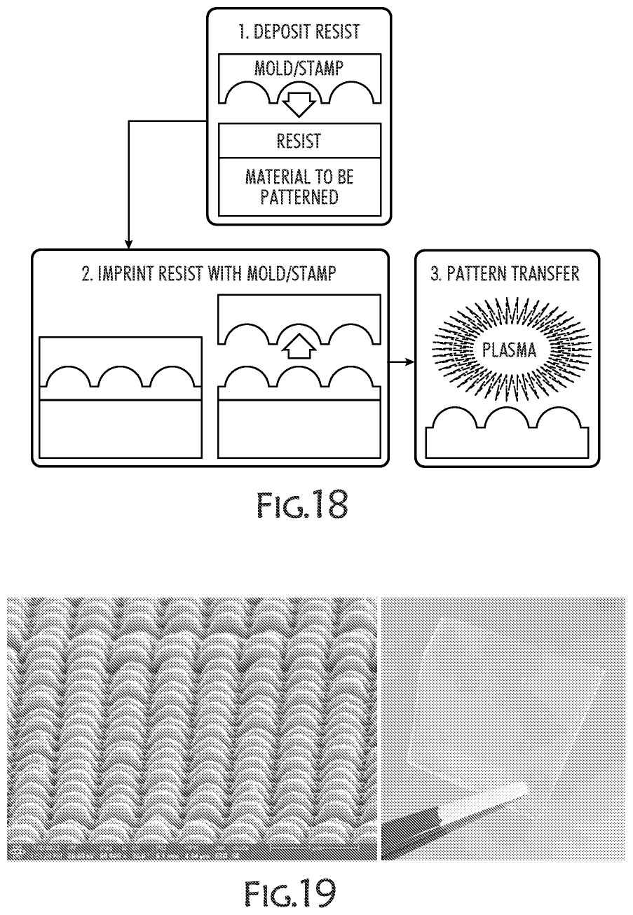

FIG. 19 shows a piece of glass that was patterned in this way, coated with a monolayer silane coating using vapor deposition, then tested for dust. The efficacy of the pattern transfer is shown by the SEM, while the efficacy of the dust mitigation is demonstrated by the photo, which includes a seam between the patterned region with purple diffraction and a smooth region with a white haze of dust.

In another example, the pattern from the mold was transferred into a polyimide precursor before the polyimide was fully cured. In this case, a fully cured polyimide film was used as a substrate, then polyimide precursor chemicals were spin coated onto the film and allowed to dry using a low temperature soft bake. Then either a PDMS or PVDF mold/stamp was used to imprint the dry film under pressure. The mold was removed, then the pattern film that remained was cured using a higher temperature hard bake. This process creates a fully cross-linked polyimide surface on a polyimide substrate. After applying a monolayer silane coating by chemical vapor deposition, the patterned region of the polyimide showed a substantial dust mitigating performance, when compared to the smooth region of the same material. This example process has the benefit of imparting the reduction in adhesion to non-thermoplastic polymers, such as polyimide, or other solution-processed materials such as sol gels.

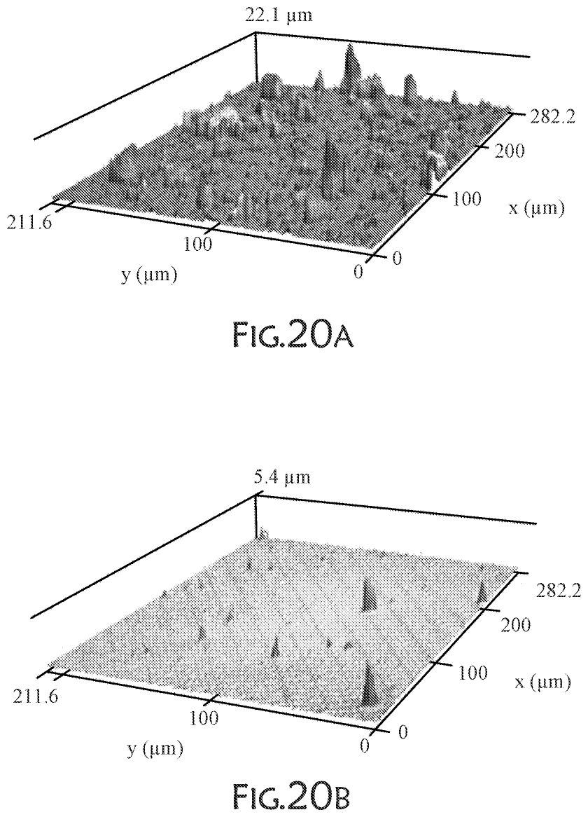

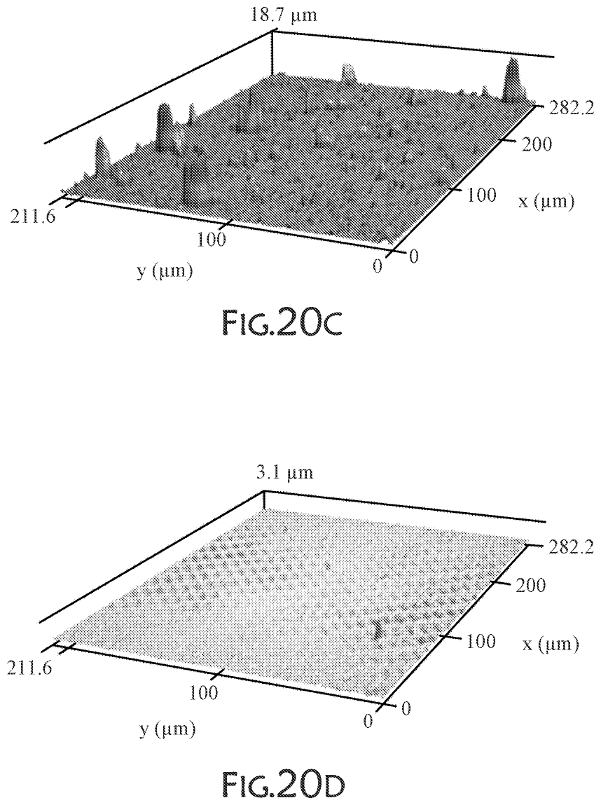

Referring to FIG. 20, 3D topographic images of the silane-treated smooth and nanostructured PC samples, for example (a) smooth sample and (b) nanostructured surface with 500 nm period after tilting vertically, (c) smooth sample and (d) nanostructured or textured surface with 500 nm period after applying centrifugal force at 500 RPM. To better compare the adhesion properties, the 3-dimensional (3D) topography of the smooth sample and the sample with 500 nm features are measured using confocal microscopy and illustrated in FIG. 20. After dust contamination and tilting vertically to remove the dust, the particles on the smooth surface have a peak height of 22.1 μm, as shown in FIG. 20A, which gives an estimate of the largest particle size that remain on the sample. In comparison, the 500 nm period sample has a low particle coverage area after dust contamination and vertically tilting to remove dust, with a peak height of 5.4 μm, as shown in FIG. 20B. After spinning the smooth sample, the peak height is reduced slightly to 18.7 μm, as shown in FIG. 20C. The peak height of the sample with 500 nm features deceases slightly to 3.1 μm after spinning the sample, as shown in FIG. 20D. These results indicate that while the particles greater than 10 μm have been mostly removed from the 500 nm sample, a few smaller particles less than 5 μm still remain. However, the 500 nm sample is mostly free from particles even before spinning, indicating that most of the particles are removed via gravity by tilting the sample vertically.

Additional aspects of the present technology are described below with respect to the following non-limiting embodiments:

Embodiment 1. A textured surface comprising a plurality of features, wherein the textured surface and/or the plurality of features are configured to reduce a surface adhesion of a particulate.

Embodiment 2. The surface of embodiment 1, wherein the plurality of features are periodically, aperiodically, regularly, or irregularly arranged features and can have center-to-center distances of 100 nm to 5000 nm.

Embodiment 3. The surface of any preceding embodiment, wherein the periodically, aperiodically, regularly, or irregularly arranged features (e.g. set or array of features) are combined with a regular or irregular set or array of larger features, wherein the set of larger features can have center-to-center distances of 1 μm to 1000 μm, for example a microlens, linear grating, or other structure.

Embodiment 4. The surface of any preceding embodiment, wherein the plurality of features have center-to-center distances of less than the wavelength of visible light, such that the surface (i.e. textured surface) remains optically transparent and does not distort an image or light.

Embodiment 5. The surface of any preceding embodiment, wherein the plurality of features can be configured to suppress Fresnel reflections and further allow greater transmission of light through a surface.

Embodiment 6. The surface of any preceding embodiment, wherein at least a portion of the plurality of features have a height of at least one third of the pitch.

Embodiment 7. The surface of any preceding embodiment, wherein at least a portion of the plurality of features have a radius of curvature less than a quarter of a pitch.

Embodiment 8. The surface of any preceding embodiment, wherein the surface is a metal, ceramic, sol-gel, glass, or polymer.

Embodiment 9. The surface of embodiment 8, wherein the polymer is at least one of a polycarbonate, COC, polyimide, FEP, PET, PTFE, ETFE, or polyethylene.

Embodiment 10. The surface of any preceding embodiment, wherein the substrate is coated with a low-energy coating.

Embodiment 11. The surface of embodiment 9, wherein the low energy coating is one of a silane, fluorine, self-assembled monolayer (SAM), a combination thereof, or another chemical surface treatment.

Embodiment 12. The surface of any preceding embodiment, wherein the surface or textured surface reduces particulate contamination relative to a planar surface or smooth surface of the same material.

Embodiment 13. A textured, patterned, or structured surface comprising a plurality of features configured to reduce surface adhesion of a particulate, and wherein the texture is generated or created by mechanically indenting the texture into the surface (e.g. indenting into a smooth substrate to create the textured surface) or mechanically indenting the texture into a mold that is replicated to form the textured surface.

Embodiment 14. The surface of embodiment 13, wherein the mechanical indenting process is a nanocoining process and/or a step-and-repeat indenting process.

Embodiment 15. The surface of embodiment 13, wherein the plurality of features are periodically, aperiodically, regularly and/or irregularly arranged features that can have center-to-center distances of 100 nm to 5000 nm.

Embodiment 16. The surface of any preceding embodiment, wherein the plurality of features can have center-to-center distance of at less than the wavelength of visible light such that the surface remains optically transparent and does not distort an image and/or light.

Embodiment 17. The surface of embodiment 15, wherein the periodically, aperiodically, regularly and/or irregularly arranged features are combined with a regular or irregular array or set of larger features, with center-to-center distances of 1 μm to 1000 μm, such as a microlens, linear grating, or other similar structure.

Embodiment 18. The surface of any preceding embodiment, wherein the plurality of features suppress Fresnel reflections and can allow greater transmission of light.

Embodiment 19. The surface of any preceding embodiment, wherein one or more features of the plurality of features have a height of at least one third of the pitch.

Embodiment 20. The surface of any preceding embodiment, wherein one or more features of the plurality of features have a radius of curvature less than a quarter of a pitch.

Embodiment 21. The surface of any preceding embodiment, wherein the surface or textured surface comprises or is a metal, ceramic, sol-gel, glass, or polymer.

Embodiment 22. The surface of embodiment 21, wherein the polymer is at least one of a polycarbonate, COC, polyimide, FEP, PET, PTFE, ETFE, or polyethylene.

Embodiment 23. The surface of any preceding embodiment, wherein the surface and/or substrate (i.e. prior to texturing) is coated with a low-energy coating.

Embodiment 24. The surface of embodiment 15, wherein the low-energy coating is at least one of silane, fluorine, or a self-assembled monolayer (SAM).

Embodiment 25. The surface of any preceding embodiment, wherein the surface or textured surface reduces particulate contamination relative to a planar or smooth surface of the same material.

Embodiment 26. The surface of any preceding embodiment, wherein the texture or pattern is created and/or generated on a mold that is replicated into or onto a material by at least one of embossing, etching, or nanoimprint lithography.

Embodiment 27. The surface of embodiment 26, wherein the replication process is a plate-to-plate, roll-to-plate, roll-to-roll process, or other replication process.

Embodiment 28. The surface of any preceding embodiment, wherein the surface or textured surface comprises a metal, a polymer, a ceramic, a sol-gel, and/or a glass. Further it will be understood that a substrate onto which a texture or pattern is replicated comprises a metal, a polymer, a ceramic, a sol-gel, and/or a glass.

Embodiment 29. The surface of any preceding embodiment, wherein the surface or textured surface is chemically treated with at least one of silane, fluorine, or self-assembled monolayer (SAM).

Embodiment 30. The surface of any preceding embodiment, wherein the texture, pattern, micro- and/or nanotexture comprises a plurality of periodically, aperiodically, and/or stochastically arranged features, wherein at least a portion of the plurality of features have center-to-center distances of 100 nm to 5000 nm.

Embodiment 31. The surface of any preceding embodiment, wherein the texture, pattern, micro- and/or nanotexture comprises a plurality of features that are spaced with center-to-center distances of less than the wavelength of visible light such that the surface remains optically transparent and does not distort an image and/or light.

Embodiment 32. The surface of embodiment 30, wherein the features are combined with a regular or irregular array or set of larger features with center-to-center distances of 1 μm to 1000 μm, such as a microlens, linear grating, or other structure.

Embodiments described herein can be understood more readily by reference to the examples described above. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A textured surface comprising:
a plurality of features, the plurality of features configured to reduce surface adhesion of a particulate, wherein the texture is generated by mechanically indenting the texture into a surface and/or by a texture transfer process.

2. The surface of claim 1, wherein the texture transfer process comprises creating a texture on a mold and replicating the texture into the surface by at least one of embossing, etching, and nanoimprint lithography.

3. The surface of claim 2, wherein the texture is generated into a mold by a mechanical indenting through nanocoining or step-and-repeat indenting.

4. The surface of claim 1, wherein the plurality of features comprise a plurality of periodically or stochastically arranged features, and wherein at least a portion of the plurality of features have center-to-center distances of 100 nm to 5000 nm.

5. The surface of claim 1, wherein at least a portion of the plurality of features have a height of at least one third of the pitch.

6. The surface of claim 1, wherein at least a portion of the plurality of features have a radius of curvature less than a quarter of a pitch.

7. The surface of claim 2, wherein the plurality of features are combined with a regular or irregular array of larger features, the larger features having center-to-center distances of 1 μm to 1000 μm.

8. The surface of claim 1, wherein the surface is a metal, ceramic, sol-gel, glass, or polymer.

9. The surface of claim 1, wherein the substrate is coated with a low-energy coating.

10. A method of forming a textured surface, comprising:
providing a surface;
generating a texture on a mold to form a textured mold; and
replicating the texture from the mold to the surface to form the textured surface, wherein the textured surface comprises a plurality of features configured to reduce surface adhesion of a particulate.

11. The method of claim 10, wherein the texture is generated onto the mold by a mechanical indenting process comprising at least one of nanocoining and/or step-and-repeat indenting.

12. The method of claim 10, wherein the plurality of features comprises a plurality of periodically or stochastically arranged features, and wherein at least a portion of the plurality of features have center-to-center distances of 100 nm to 5000 nm.

13. The method of claim 10, wherein at least a portion of the plurality of features have a height of at least one third of a pitch.

14. The method of claim 10, wherein at least a portion of the plurality of features have a radius of curvature less than a quarter of a pitch.

15. The method of claim 10, wherein at least a portion of the plurality of features are combined with a regular or irregular array of larger features, the larger features having center-to-center distances of 1 μm to 1000 μm.

16. The method of claim 10, wherein the substrate and/or the textured surface is coated with a low-energy coating.

17. The method of claim 10, wherein the textured mold is generated by at least one of embossing, etching, and nanoimprint lithography.

18. The method of claim 17, wherein the replicating is a plate-to-plate, roll-to-plate, roll-to-roll process, or other replication process.

19. The method of claim 10, wherein the textured surface comprises a metal, a polymer, a ceramic, a sol-gel, or a glass.

20. The surface of claim 10, wherein the textured surface reduces particulate contamination relative to a planar surface of the same material by at least 70%.
